(19) United States
(12) Patent Application Publication
(10) Pub. No.: US 2005/0028412 A1
(43) Pub. Date: Feb. 10, 2005

(54) Aquatic Neon art

(76) Inventor: Jong Koo Kim, Los Angeles, CA (US)

Correspondence Address: JONG KOO KIM, 3310 W. ADAMS BLVD. #201, LOS ANGELES, CA, 90018-5403, US

(21) Appl. No.: 10/633,400

(22) Filed: Aug. 4, 2003

(51) Int. Cl. G09F 13/00

(52) U.S. Cl. 40/442

(57) ABSTRACT

This invention discloses a method for creating a variable colored effect like neon light and creating a variety of figures like neon sign in the wall and floor of swimming pools, spas, aquariums, fountains, waterfalls and Ice rink atc.

### FIELD OF THE INVENTION

This invention discloses a method for creating a variable colored lighting effect like Neon Light in the water's wall and floor.

### BACKGROUND OF THE INVENTION AND OBJECTS

In the field of Neon art was using in the air during the couple of centuries. And it was difficult Neon to install under water, because the electricity is dangerous. It is also dangerous when it breaks in the water because of the glass. But with an acrylic core named Light Guide (made from Bridgestone Industrial products America, Inc) with L.E.D.Point light or laser beam, there is no problem installing or decorating under water. First of all, the electricity comes until electric safe zone. And then, from there installed L.E.D. light or laser beam and acrylic core carry the light into the water.

### SUMMARY OF THE INVENTION

The Acrylic core with L. E. D. point light brighten effect as neon light in the night. Now, the world can enjoy seeing swimming pool, spas, aquarium, fountain, waterfall, ect. decorated by multi-color of effect Neon inside the water. Also, It'll use not only decoration but also utility; For example, handle bar of swimming pool, the mark of the depth of water, the mark of the stairway of swimming pool, etc . . . in case of aquarium, could show AQUARIUM THEATER means in stage decorated Aquatic Neon Art, actor or actress with some fish or animals will be playing some performance.

### THE DRAWINGS

FIG. 1 is a schematic view of embodiment of the method installed simple.

FIG. 2 is a schematic view of embodiment of the method installed combination of available thickness and color.

### DESCRIPTION OF PREFERRED EMBODIMENTS

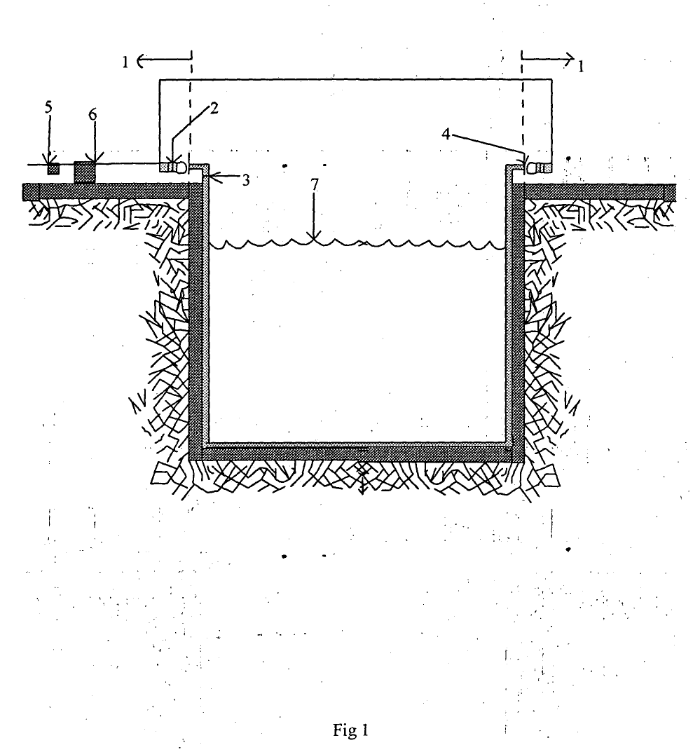

In FIG. 1 the electricity comes until border of electric safe zone (No. 1) and L.E.D. Light or laser beam illuminates the end of Acrylic core (No. 2) and Acrylic core carry the colorful light into the water (No. 3) and it makes any figure on the wall or the floor and come out from the water, and joins with another L.E.D. light or laser beam illuminated. (No. 4). And (No. 5) is swich And (No. 6) is transform and (No. 7) is surface of water.

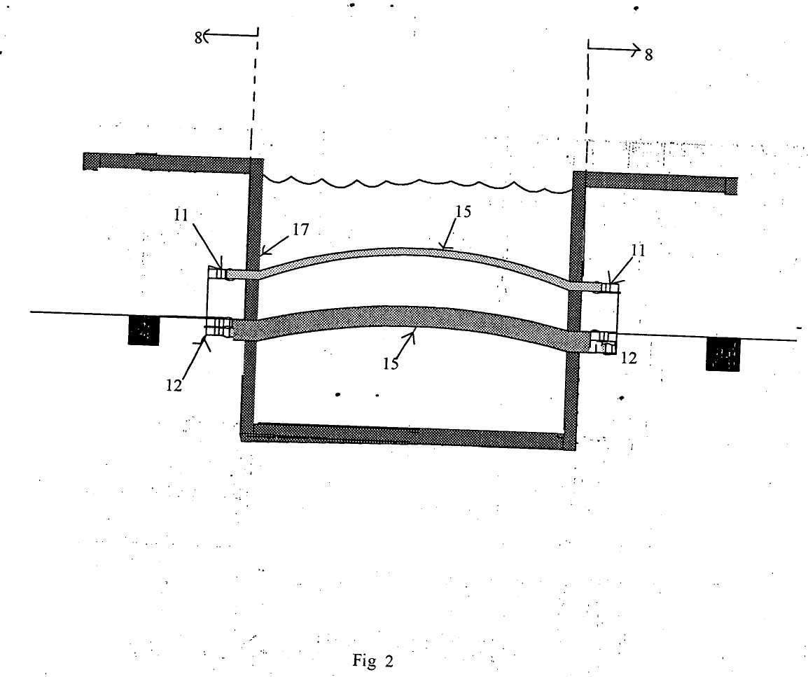

In FIG. 2 is in case of various color and different thickness, Also the electricity comes until border of electric safe zone (No. 8) And in case of singular L.E.D. light or laser beam illuminates (No. 11) And duplex L.E.D. light or laser beam illuminates (No. 12) joins with End of Acrylic core and Acrylic core carry the colorful light into the water through the wall (No 7) and it makes any figure on the wall (No. 15) and keep going through the wall and joins with another L.E.D. light or laser beam illuminated. (No. 11) and (NO. 12). The arrangement is well known to persons knowledgeable of the field.

1. An ornamental aquatic neon art comprising:
Illuminated acrylic core install or decorate under water's wall and floor as if installed neon sign in the air.
